(19) United States
(12) Patent Application Publication
(10) Pub. No.: US 2025/0371828 A1
(43) Pub. Date: Dec. 4, 2025

(54) Visual Enhancement and Object Tracking For Mixed Reality Devices

(71) Applicant: Apple Inc., Cupertino, CA (US)

(72) Inventors: Rick Wong, Seattle, WA (US); Louis W Bokma, Eagle, ID (US)

(21) Appl. No.: 19/194,289

(22) Filed: Apr. 30, 2025

Related U.S. Application Data
(60) Provisional application No. 63/653,381, filed on May 30, 2024.

(51) Int. Cl. G06T 19/20; G06T 19/00; G06V 20/20

(52) U.S. Cl. CPC G06T 19/20; G06T 19/006; G06V 20/20

(57) ABSTRACT

Various implementations disclosed herein include devices, systems, and methods that enhance a specified object or a specified region within a view of an XR environment. For example, a process may present a first view of an extended reality (XR) environment to a user. The process many further detect an enhancement triggering condition associated with viewing an object or region of the XR environment based on sensor data. The enhancement triggering condition may be detected based on: identifying objects or regions of the XR environment. The process may further determine that a display attribute associated with the object or region of the XR environment satisfies a criterion for enhanced display of the object or region and based on the display attribute satisfying the criterion, the object or region is modified in a second view of the XR environment.

### CROSS-REFERENCE TO RELATED APPLICATIONS

This application claims the benefit of U.S. Provisional Application Ser. No. 63/653,381 filed May 30, 2024, which is incorporated herein in its entirety.

### TECHNICAL FIELD

The present disclosure generally relates to systems, methods, and devices that enhance objects or regions within a view of an extended reality (XR) environment.

### BACKGROUND

Existing techniques for enabling a user to view obscured or distant content on a display of a device may be improved with respect to visibility and accuracy to provide desirable viewing experiences.

### SUMMARY

Various implementations disclosed herein include devices, systems, and methods that provide enhancements for specified objects or regions (e.g., that include text) within a view of an XR environment based on an enhancement triggering condition such as determined user intent and/or a context with respect to an object or region such as, inter alia, wildlife in a nature setting (e.g., a bird in a tree, a scoreboard in an arena or stadium, notes or text written by a teacher or professor in a classroom setting, a license plate of an automobile, etc.). Object or region enhancements may include, inter alia, magnification enhancements, illumination enhancements, display mode indicator enhancements, invisible light and/or night vision capability enhancements, etc.

In some implementations, user intent and/or a context may be determined by detecting a user gaze position (e.g., with respect to an object or region) and/or based on a physical input such as, inter alia, a hand gesture, etc. If user intent and/or a context is detected, then in some implementations, a size or depth of the object or region may be compared to a threshold value and the object or region may be enhanced in accordance results of the comparison. For example, comparing a size of an object or region may result in determining that a size of the object or region is below a threshold size and therefore the object or region may be enhanced by magnification, etc. Likewise, comparing a depth of an object or region may result in determining that a depth of the object or region exceeds a threshold depth and therefore an enhancement may be applied.

In some implementations, object or region enhancements may be performed by enhancing (e.g., enlarging, adjusting illumination properties, etc.) just an object or region itself. Alternatively, object or region enhancements may be performed by segmenting an object or region out from an XR environment and just enhancing the object or region. In some implementations a background region (e.g., in an XR environment) surrounding an object or region may be, inter alia, totally masked out, made semi-transparent, blurred out (e.g., out of focus), etc. In some implementations, a background region surrounding an object or region may be enhanced in a different manner (different size, color, transparency level, etc.) than an enhancement for the object or region dependent upon what type of object or region is detected. For example, a background region surrounding an object or region may be modified to include a different size, color, transparency level, etc. with respect to size, color, transparency level, etc. a corresponding object or region.

In some implementations, a further user gesture (e.g., a gaze and/or hand gesture) may be used to return an enhanced (e.g., magnified) object or region back to an original level after viewing the enhanced object or region.

In some implementations, object or region enhancements may be performed based on whether a determined user intent and/or a context is associated with an object or a region. For example, an object (e.g., an animal in a photo) may be enhanced differently (e.g., only the animal is magnified) than a region (e.g., an entire region may be magnified for text).

In some implementations, an electronic device has a processor (e.g., one or more processors) that executes instructions stored in a non-transitory computer-readable medium to perform a method. The method performs one or more steps or processes. In some implementations, the electronic device presents, to a user via one or more displays of the electronic device, a first view of an XR environment. In some implementations, an enhancement triggering condition associated with viewing at least a portion of an object or a region of the XR environment is detected based on sensor data obtained via the one or more sensors. The enhancement triggering condition may be detected based on: identifying a plurality of objects or regions of the XR environment. In some implementations, it may be determined that a display attribute associated with the object or region of the XR environment satisfies a criterion for enhanced display of the object or region and based on the display attribute satisfying the criterion, the object or region is modified in a second view of the XR environment.

In some implementations, an electronic device has a processor (e.g., one or more processors) that executes instructions stored in a non-transitory computer-readable medium to perform a method. The method performs one or more steps or processes. In some implementations, the electronic device obtains image data corresponding to a physical environment. The image data may be obtained via one or more sensors from a viewpoint. In some implementations, objects or regions of the physical environment depicted in a plurality of portions of the image data may be identified relative depths amongst the objects or regions depicted in the plurality of portions of the image data may be determined. The relative depths may correspond to distances of the objects or regions of the physical environment from the viewpoint. In some implementations, a boundary for an object or region of the physical environment depicted in the image data may be determined for enhanced viewing. The boundary may be determined based on the relative depths amongst the objects or region depicted in the plurality of portions of the image data. In some implementations, a view of an XR environment may be presented to a user via a display. The view of the XR environment that depicts the physical environment with an enhancement provided for the object or region based on the determined boundary.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2E illustrate a process for enhancing content, such as an object, presented via a display of a device, in accordance with some implementations.

FIGS. 3A-3E illustrate a process for enhancing content, such as text of a region, presented via a display of a device, in accordance with some implementations.

FIG. 4 is a flowchart representation of an exemplary method that enhances an object or a region within a view of an XR environment based on determined user intent and/or a context, in accordance with some implementations.

FIG. 5 is a flowchart representation of an exemplary method that selects boundaries for an enhancement of a region within a view of an XR environment based on an understanding of the XR environment, in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

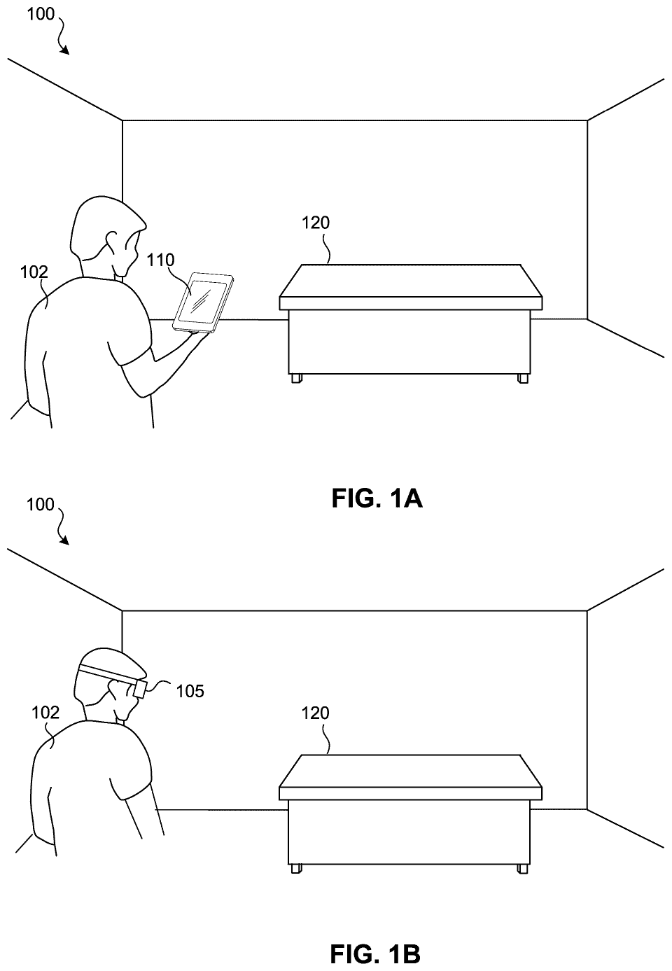

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an XR environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

Various implementations disclosed herein include devices, systems, and methods that implement gaze tracking approaches that use image data. In some implementations, gaze may be tracked using imaging data to determine eye position or eye orientation using a pupil plus glint model, using a depth camera (e.g., stereo, structured light projection, time-of-flight (ToF), etc.) with 3D point cloud registration, or using an appearance-based model.

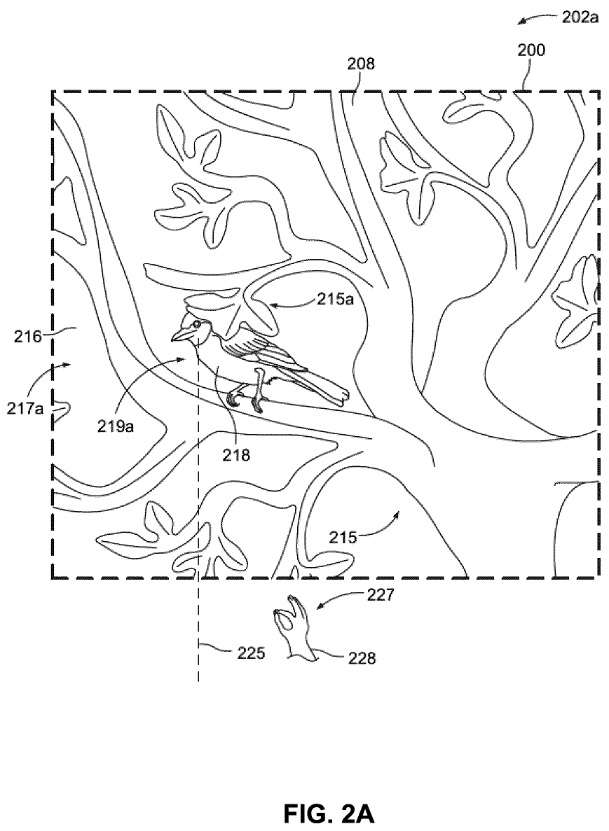

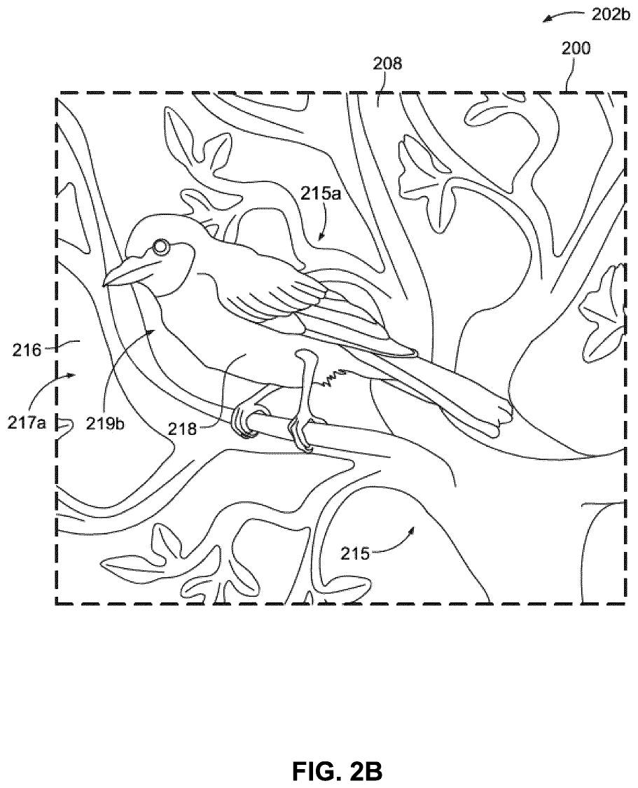

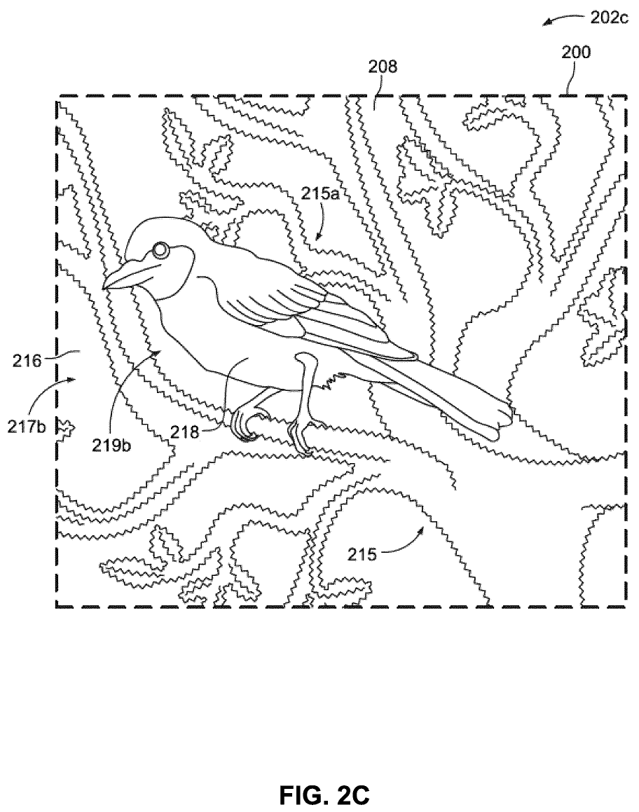

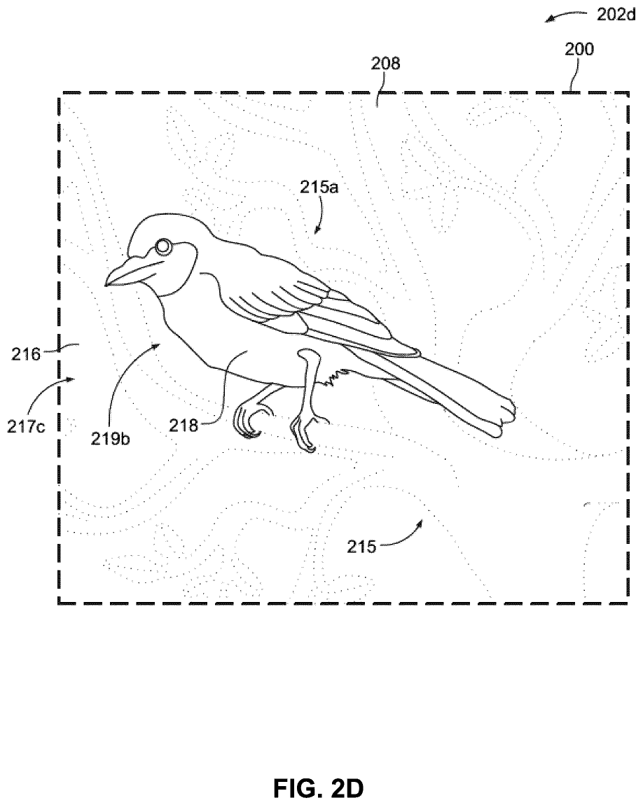

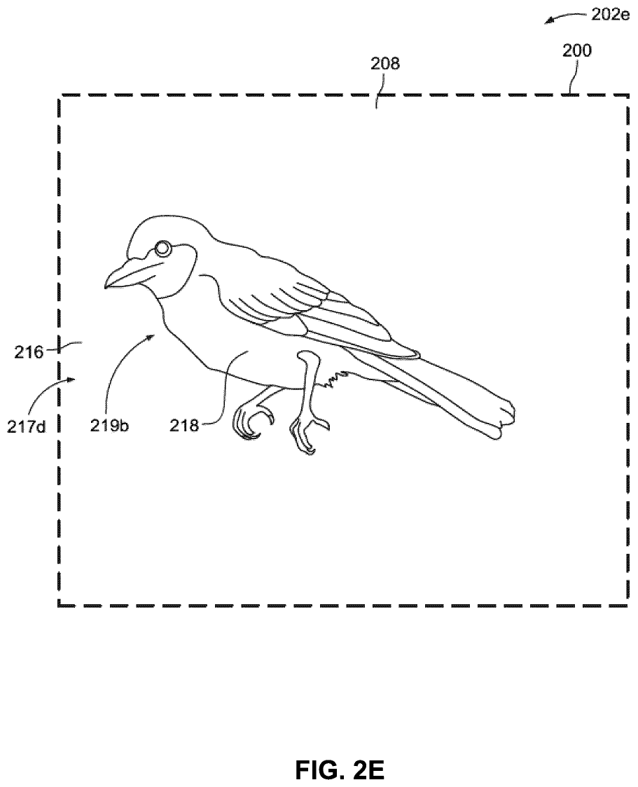

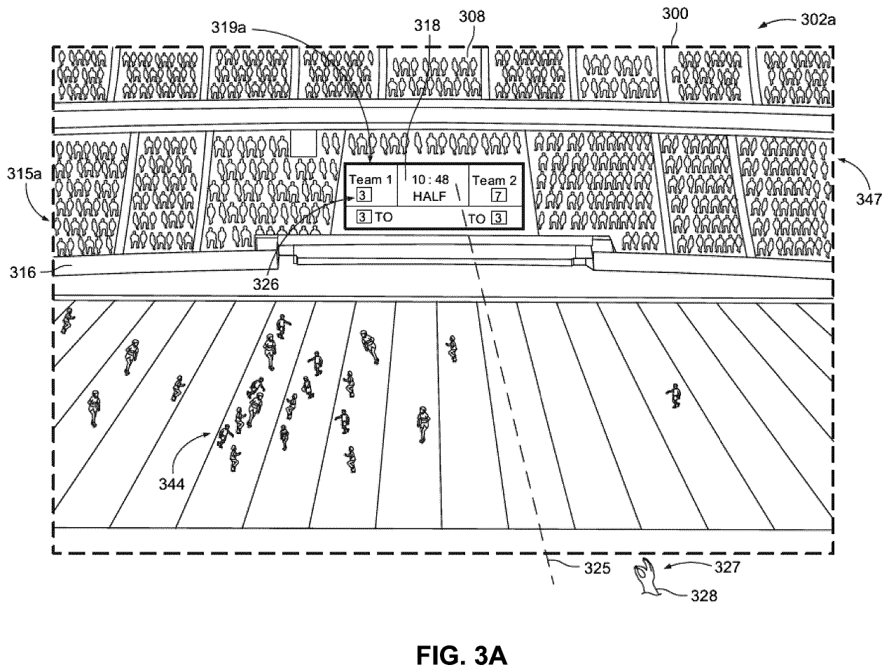

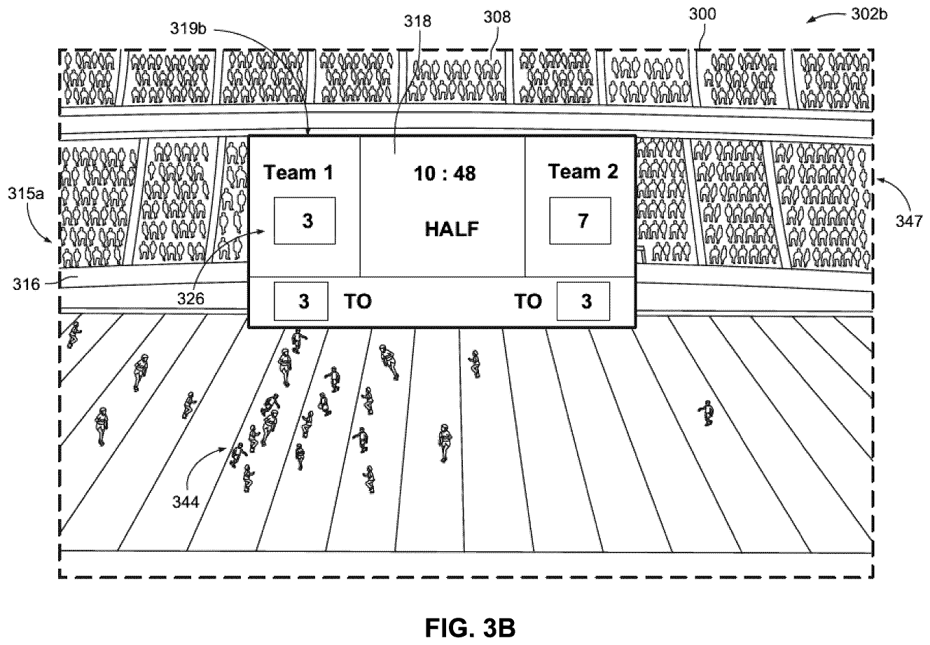

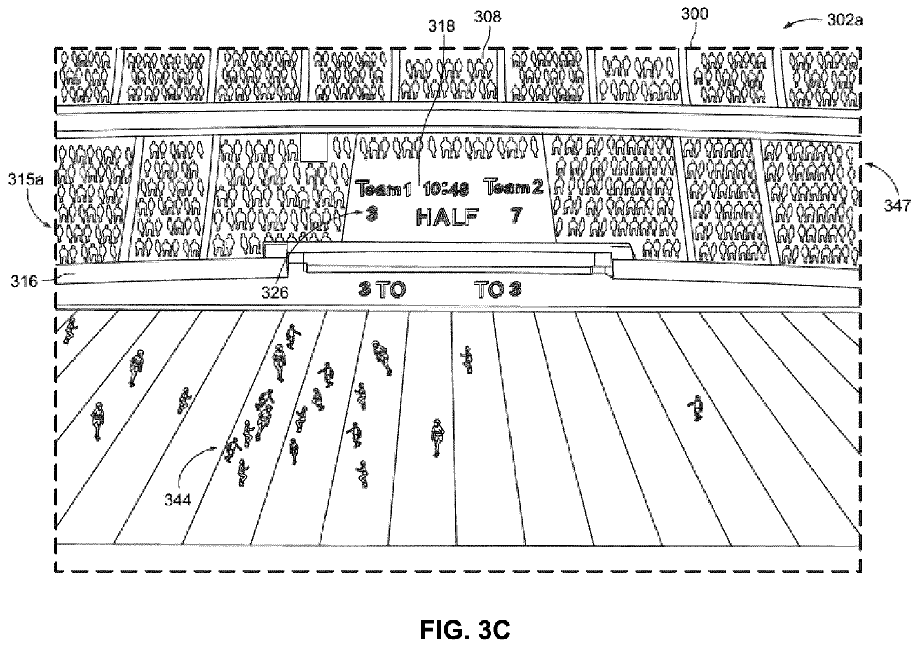

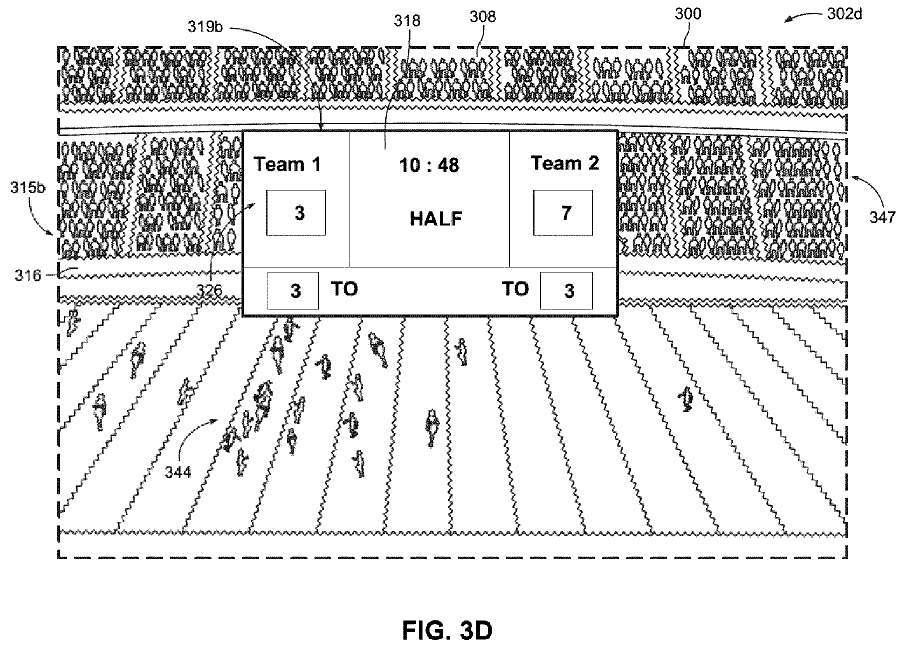

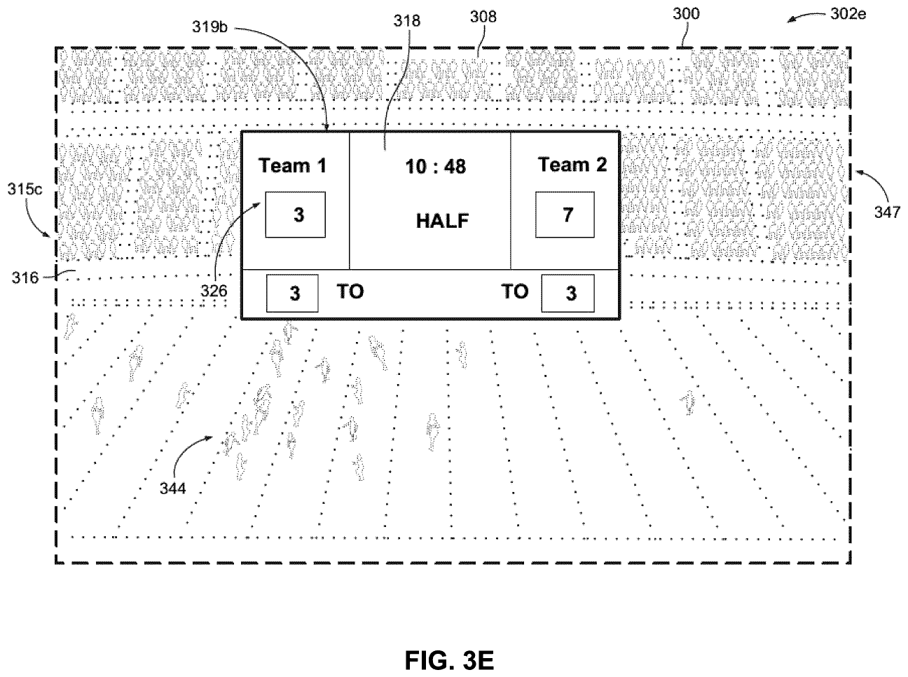

In some implementations, an object or region (e.g., wildlife in a nature setting (e.g., as described with respect to FIGS. 2A-2E), a scoreboard in an arena or stadium (e.g., as described with respect to FIGS. 3A-3E), notes or text written by a teacher or professor in a classroom setting, a license plate of an automobile, etc.) within a view of an XR environment may be enhanced or modified (e.g., magnified) based on an enhancement triggering condition associated with viewing (e.g., detected user intent or user activity) with respect to the object or region. For example, determined user intent may indicate that a user intends to view a license plate of an automobile and in response, a text portion of the license plate is magnified to capture an enhanced view of the license plate that is ephemerally within view of the user.

In some implementations, an object or region within a view of an XR environment may be automatically (or via user invocation) enhanced or modified (e.g., magnified) based on a context of the object or region. For example, if it is determined (e.g., via a device such as an HMD) that a user is at a football game, then specified objects within a stadium/arena may be automatically enhanced or magnified (e.g., a scoreboard region 318 as described with respect to FIG. 3B, infra). Automatically enhancing an object or region within a view of an XR environment based on context may be performed independently or in combination with detecting user intent.

In some implementations, an initial view of an XR environment may be presented to a user (e.g., user 102) via a display(s) of a device such as, an HMD. The XR environment may include images and/or depictions of a physical environment (e.g., physical environment 100).

In some implementations, a context associated with an object or a region of the XR environment may be determined based on sensor data obtained via sensors (e.g., sensors of a device, external sensors, etc.). A context associated with the object or region may be determined based on identification of objects or regions of the XR environment. For example, identification of objects or regions of the XR environment may be based on knowledge or detection of a location of objects or regions located within the XR environment. In some implementations, detection of a location of objects or regions may include object/region detection (e.g., via sensors), semantic labeling, scene understanding, etc. In some implementations, artificial intelligence (AI) and/or machine learning (ML) techniques may be used to identify the existence of an object or region and track and focus on the object or region within the field of view of the device (e.g., HMD).

In some implementations, the user intent and/or a context with respect to viewing the object or region may be predicted based on detecting a user activity indicative of intent to view the object or region. For example, detecting a user activity may include, inter alia, determining that the user is looking at a particular object or object of a particular type, determining that the user makes a particular gesture while looking at an object or region, etc.

In some implementations, it may be determined that a display attribute associated with the object or region of the XR environment satisfies a criterion for enhanced display of the object or region. For example, satisfying a criterion for enhanced display may include determining that a size of text in a view (e.g., pixel height of text) is smaller than a threshold size, determining that a distance of an object from a viewpoint exceeds a threshold distance, etc.

In some implementations, based on the display attribute satisfying a criterion, the object or region may be enhanced (e.g., enlarged and presented closer to a viewpoint) in subsequent view of the XR environment.

In some implementations, an indicator may be enabled for notifying a user that an enhancement mode has been activated thereby indicating that a user peripheral vision may be limited.

In some implementations, the object or region may be enhanced to enable detailed, close-up observations that may be beneficial for audiences such as, inter alia, students, researchers, and collectors of items like (e.g., insects, stamps, coins, etc.). Likewise, the object or region may be enhanced to enable viewing tasks requiring microscopic inspection. In some implementations, the object or region may be enhanced with respect to medical imaging features to enable, for example, a medical professional to view detailed images thereby improving diagnostic and treatment accuracy.

In some implementations, invisible light and night vision capabilities may be enabled with respect to object or region enhancements.

In some implementations, a further user gesture (e.g., a gaze and/or hand gesture) may be used to return an enhanced (e.g., magnified) object or region back to an original level after viewing the enhanced object or region.

FIGS. 2A-2E illustrate a process for enhancing content 208 presented via a display 200 of a device such as device 105 or 110 of FIG. 1, in accordance with some implementations.

FIG. 2A illustrates an example of display 200 presenting an initial view 202a of content 208 depicted in an XR environment. Initial view 202a of content 208 comprises a view 219a of an object 218 (i.e., a bird) and a view 217a of a background region 216 (e.g., a surrounding scene) surrounding the object 218. Background region 216 includes a tree 215 with a branch 215a partially obscuring object 218 from being viewed by a user such as user 102 of FIG. 1.

In some implementations, a process for enhancing or modifying content 208 may be initiated in response an enhancement triggering condition such as predicting user intent to view at least a portion of an object such as, inter alia, object 218 and/or determining a context associated with the object. In some implementations, user intent to view at least a portion of an object may be predicted based on sensor data obtained via a sensor(s). An intent to view an object or context may be predicted based on identifying all objects within the XR environment and detecting a user activity indicative of intent to view at least one of the objects. In some implementations, an object or region within a view of an XR environment may be automatically (or via user invocation) enhanced or modified (e.g., magnified) based on a context of the object or region.

In some implementations, an object or region within a view of an XR environment may be automatically (or via user invocation) enhanced (e.g., magnified) based on a predefined context trigger or threshold. For example, an object or region may be enhanced if a size of a specified object type (e.g., letters or numbers on a license plate) is less than a specified dimension.

In some implementations, identifying all objects within the XR environment may include, inter alia, detecting objects and associated locations within the XR environment, performing a semantic labeling process, performing a scene understanding process, etc.

In some implementations, detecting a user activity indicative of intent to view the object 218 may include, for example, detecting a user gaze direction/location (illustrated by ray 225) with respect to object 218 thereby indicating predicted user intent with respect to viewing object 218. Additionally, a hand gesture such as a pinch gesture 227 (e.g., fingers of hand 228 coming together and touching) or finger direction may be detected (instead of or in combination with the user gaze direction/location illustrated by ray 225) thereby indicating predicted user intent with respect to viewing object 218. In some implementations, detecting a user activity indicative of intent to view the object 218 may include, for example, detecting eye squinting or an eye behavior indicative of a user struggling to view object 218. The user activity may be associated with conscious or unconscious actions.

In some implementations, it may be determined that a display attribute associated with object 228 satisfies a criterion for enabling an enhanced display of object 218. For example, it may be determined that a distance of object 218 with respect to a viewpoint (e.g., user/camera viewpoint) exceeds or is below a threshold distance value. Likewise, it may be determined that a viewing size of object 218 is smaller or larger than a threshold size value. If it is determined that a display attribute associated with object 228 satisfies a criterion for enabling an enhanced display of object 218, then a process for enhancing or modifying the object 218 may be executed as described with respect to FIGS. 2B-2E, infra.

In some implementations, object 218 may be segmented out from the XR environment prior to enhancing object 218. In some implementations, background region 216 surrounding object 218 may be enhanced in a different manner (e.g., a different size, color, transparency level, etc.) than an enhancement for object 218.

In some implementations, initial view 202a of content 208 may be composed of image data and relative depths among objects (e.g., object 218 and additional objects or background region 216) depicted in portions of the image data may be determined. The relative depths among the objects may correspond to distances of the objects of the XR environment from a viewpoint. For example, an object A may be 5 feet away from a camera viewpoint and an object B may be adjacent to object A but may be located 10 feet away from the camera viewpoint. In this instance, a boundary for an object depicted in the image data may be determined for enhanced viewing. The boundary may be determined based on the relative depths amongst the objects depicted in the portions of the image data.

FIG. 2B illustrates an example of display 200 presenting a view 202b of content 208 subsequent to enhancing or modifying object 218 of the XR environment. View 202b of content 208 comprises an enhanced view 219b of object 218 with respect to view 217a of background region 216.

A comparison between FIGS. 2A and 2B illustrates distinctions between the initial view 202a of FIG. 2A and view 202b of FIG. 2B. For example, view 202b (of FIG. 2B) of content 208 includes enhanced view 219b illustrating object 218 occupying a larger area (and closer to a view point) of display 200 (e.g., a magnified view of object 218 via intelligent zooming coupled with artificial intelligence (AI) and/or machine learning (ML) image enhancement) than view 219a of object 218 as illustrated in FIG. 2A. View 202b including enhanced view 219b of object 218 improves initial view 202a of content 208 such that object 218 (and associated details of object 218) is enlarged thereby improving a user viewing experience by enabling a better view of object 218. Likewise, enhanced view 219b of object 218 occupying a larger area of display 200 may further separate object 218 from background region 216 such that tree 215 appears further in a background and branch 215a is no longer obscuring any portion of object 218.

In some implementations, view 202b may further present object 218 and background region 216 in a different manner than view 202a. For example, view 202b may present object 218 with enhanced colors (e.g., brighter and more illuminated colors) and/or background region 216 occupying a smaller area of display 200.

FIG. 2C illustrates an example of display 200 presenting a (alternative) view 202c of content 208 subsequent to enhancing object 218 of the XR environment. Similar to view 202b of FIG. 2B, view 202c comprises enhanced view 219b of object 218 with respect to background region 216. In contrast with FIG. 2B, view 202c illustrates an alternative view 217b presenting background region 216 as blurred out (e.g., out of focus). Accordingly, tree 215 and branch 215a are presented out of focus thereby allowing a fully magnified view of object 218 to be isolated from tree 215 further enhancing a user viewing experience with respect to a view of object 218.

FIG. 2D illustrates an example of display 200 presenting a (alternative) view 202d of content 208 subsequent to enhancing object 218 of the XR environment. Similar to view 202b of FIG. 2B, view 202d comprises enhanced view 219b of object 218 with respect to background region 216. In contrast with FIG. 2B, view 202d illustrates an alternative view 217c presenting background region 216 as transparent. Accordingly, tree 215 and branch 215a are presented in a transparent manner thereby allowing a fully magnified view of object 218 to be further isolated from tree 215 further enhancing a user viewing experience with respect to a view of object 218.

FIG. 2E illustrates an example of display 200 presenting a (alternative) view 202e of content 208 subsequent to enhancing object 218 of the XR environment. Similar to view 202b of FIG. 2B, view 202e comprises enhanced view 219b of object 218 with respect to background region 216. In contrast with FIG. 2B, view 202e illustrates an alternative view 217d eliminating background region 216 (e.g., masking out). Accordingly, background region 216 is no longer presented thereby allowing a fully magnified view of object 218 to be completely isolated from tree 215 further enhancing a user viewing experience with respect to a view of object 218.

FIGS. 3A-3E illustrate a process for enhancing content 308 (e.g., text 326 of a region 318) presented via a display 300 of a device such as device 105 or 110 of FIG. 1, in accordance with some implementations.

FIG. 3A illustrates an example of display 300 presenting an initial view 302a of content 308 depicted in an XR environment. Initial view 302a of content 308 comprises a view 319a of a region 318 (a scoreboard) that includes text 326 (e.g., team names and associated scores) and a view 315a of a background region 316 surrounding the object 318 (e.g., a surrounding scene). Background region 316 includes a view of a stadium (or arena) hosting a sporting event 344 for an audience 347.

In some implementations, a process for enhancing content 308 (e.g., text 326 of a region 318) may be initiated in response to predicting user intent to view at least a portion of region 318. In some implementations, user intent to view at least a portion of region 318 may be predicted based on sensor data obtained via a sensor(s). An intent to view a portion of region 318 may be predicted based on identifying all objects and regions within the XR environment and detecting a user activity indicative of intent to view at least a portion of region 318.

In some implementations, a process for enhancing or modifying content 308 (e.g., text 326 of a region 318) may be initiated in response to determining on a context of region 318. In some implementations, a context of region 318 may be predicted based on sensor data obtained via a sensor(s) and a context may be predicted based on identifying all objects and regions within the XR environment.

In some implementations, identifying all objects and regions within the XR environment may include, inter alia, detecting objects, regions, and associated locations within the XR environment, performing a semantic labeling process, performing a scene understanding process, etc.

In some implementations, detecting a user activity indicative of intent to view the object or region may include, for example, detecting a user gaze direction/location (illustrated by ray 325) with respect to region 318 thereby indicating predicted user intent with respect to viewing text 326 (e.g., to obtain a better view of the score of the sporting event). Additionally, a hand gesture such as a pinch gesture 327 (e.g., fingers of hand 328 coming together and touching) or finger direction may be detected (instead of or in combination with the user gaze direction/location illustrated by ray 325) thereby indicating predicted user intent with respect to viewing text 326.

In some implementations, it may be determined that a display attribute associated with text 326 satisfies a criterion for enabling an enhanced display of region 318 and/or text 326. For example, it may be determined that a distance of region 318 with respect to a viewpoint (e.g., user/camera viewpoint) exceeds a threshold distance value. Likewise, it may be determined that a viewing size of text 326 in a predicted view (e.g., pixel height of text 326) is smaller than a threshold size value. If it is determined that a display attribute associated with text 326 satisfies a criterion for enabling an enhanced display of region 318 and/or text 326, then a process for enhancing region 318 and/or text 326 may be executed as described with respect to FIGS. 3B-3E, infra.

In some implementations, a display attribute may be an object type. For example, if the object is a scoreboard, then the scoreboard will always be enhanced. In this instance, the enhancement may be performed at a specified region of a user's field of view (e.g., a top left corner of a display region). Additionally, if the object (e.g., scoreboard) is located close to the user, then a view of the object may be enhanced by decreasing a viewing size of the object and/or moving the object to a more comfortable region of a user's field of view. Determining to enhance the object may be based on context. In some implementations, placement of the enhanced object with respect to display location may be based on user input and/or context. For example, a scoreboard should not be placed in a location blocking a view of the game and may be placed instead at a location over viewers in a stadium.

In some implementations, region 318 and/or text 326 may be segmented out from the XR environment prior to enhancing region 318 and/or text 326. In some implementations, background region 316 surrounding region 318 and text 326 may be enhanced in a different manner (e.g., a different size, color, transparency level, etc.) than an enhancement for region 318 and/or text 326.

In some implementations, initial view 302a of region 318 and/or text 326 may be comprised by image data and relative depths among regions (e.g., region 318 and additional regions or background region 316) depicted in portions of the image data may be determined. The relative depths among the regions may correspond to distances of the regions of the XR environment from a viewpoint. For example, a region A may be 5 feet away from a camera viewpoint and a region B may be adjacent to region A but located 10 feet away from the camera viewpoint. In this instance, a boundary for a region (e.g., region 318) depicted in the image data may be determined for enhanced viewing. The boundary may be determined based on the relative depths amongst the regions depicted in the portions of the image data.

FIG. 3B illustrates an example of display 300 presenting a view 302b of content 308 subsequent to enhancing region 318 and text 326 of the XR environment. View 302b of content 308 comprises an enhanced view 319b of region 318 and text 326 with respect to view 315a of background region 316.

A comparison between FIGS. 3A and 3B illustrates distinctions between the initial view 302a of FIG. 3A and view 302b of FIG. 3B. For example, view 302b (of FIG. 3B) of content 308 includes enhanced view 319b illustrating region 318 and text 326 occupying a larger area of display 300 (e.g., a magnified view of region 318 including a larger version of text 326 generated via intelligent zooming coupled with AI/ML image enhancement) and presented closer to a viewpoint than view 319a of region 318 and text 326 as illustrated in FIG. 3A. View 302b including enhanced view 319b of region 318 and text 326 improves initial view 302a of content 308 such that region 318 and text 326 are enlarged or magnified thereby improving a user viewing experience by enabling a better view of region 318 and text 326. Likewise, enhanced view 319b of region 318 and text 326 occupying a larger area of display 300 may further separate region 318 and text 326 from background region 316 such that background region 316 appears further in a background.

In some implementations, view 302b may further present region 318 and/or text 326 and background region 316 in a different manner than view 302a. For example, view 302b may present region 318 and/or text 326 with enhanced colors (e.g., brighter and more illuminated colors) and/or background region 316 occupying a smaller area of display 300.

FIG. 3C illustrates an example of display 300 presenting a (alternative) view 302c of content 308 subsequent to enhancing text 326 of the XR environment. In contrast to view 302b of FIG. 3B, view 302c comprises an alternative view 319c comprising only text 326 (without region 318) being enhanced (e.g., enlarged with and presented closer to a viewpoint) respect to background region 316.

FIG. 3D illustrates an example of display 300 presenting a (alternative) view 302d of content 308 subsequent to enhancing region 318 and/or text 326 of the XR environment. Similar to view 302b of FIG. 3B, view 302d comprises enhanced view 319b of region 318 and/or text 326 with respect to background region 316. In contrast with FIG. 3B, view 302d of FIG. 3D illustrates an alternative view 315b presenting background region 316 as blurred out (e.g., out of focus). Accordingly, background region 316 is presented out of focus thereby allowing a fully magnified view of region 318 and text 326 to be isolated from background region 316 further enhancing a user viewing experience with respect to a view of region 318 and text 326.

FIG. 3E illustrates an example of display 300 presenting a (alternative) view 302e of content 308 subsequent to enhancing region 318 and text 326 of the XR environment. Similar to view 302b of FIG. 3B, view 302e comprises enhanced view 319b of region 318 and text 326 with respect to background region 316. In contrast with FIG. 3B, view 302e illustrates an alternative view 315c presenting background region 316 as transparent. Accordingly, background region 316 is presented in a transparent manner thereby allowing a fully magnified view of region 318 and text 326 to be further isolated from background region 316 further enhancing a user viewing experience with respect to a view of region 318 and text 326.

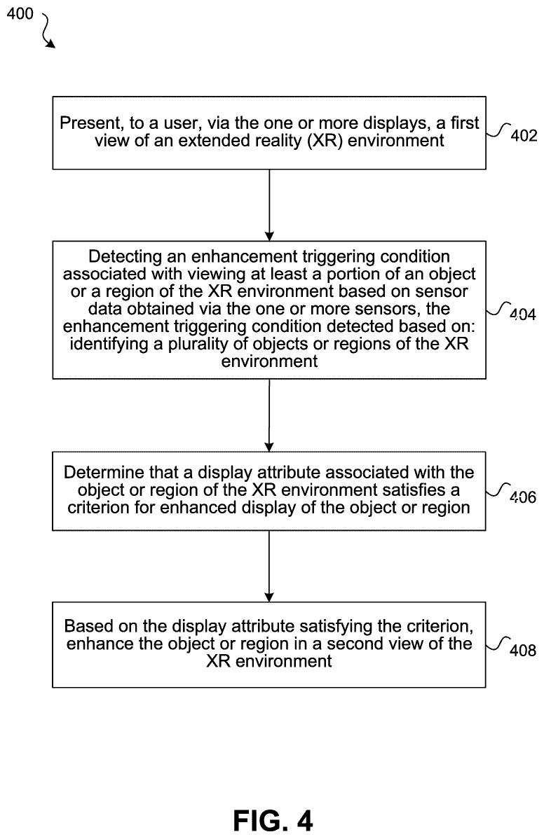

FIG. 4 is a flowchart representation of an exemplary method 400 that enhances an object (e.g., a bird) or a region within a view of an XR environment based on determined user intent, in accordance with some implementations. In some implementations, the method 400 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 presents, to a user via one or more displays of a device such as an HMD, a first view of an extended reality (XR) environment. The XR environment may include images/depictions of a physical and/or virtual environment such as a desk 120 as illustrated in FIGS. 1A and 1B and/or content 208 (e.g., depicting an object 218 (a bird) and a tree 215) as illustrated in FIG. 2A.

At block 404, the method 400 detects an enhancement triggering condition (e.g., an intent to view and/or a context) associated with viewing at least a portion of an object or a region (e.g., including text as described with respect to FIG. 3A) of the XR environment based on sensor data obtained via one or more sensors of the device. In some implementations, the enhancement triggering condition may be detected based on identifying a plurality of objects or regions of the XR environment (e.g., knowledge or detection of a location of objects or regions located within the XR environment, semantic labeling, scene understanding, etc. as described with respect to FIGS. 1A and 1B). For example, detecting an enhancement triggering condition (e.g., a user activity indicative of intent to view) may include determining that the user is looking at a particular object or object of a particular type (a user gaze direction/location illustrated by ray 225 is directed at the object 218 as described with respect to FIG. 2A), determining that the user initiates a specified gesture (a hand gesture such as a pinch gesture 227 as described with respect to FIG. 2A), etc. In some implementations, the enhancement triggering condition may be detected based on detecting a user activity indicative of the enhancement triggering condition.

At block 406, the method 400 determines that a display attribute associated with the object or region of the XR environment satisfies a criterion for enhanced display of the object or region. For example, it may be determined that: a size of text in a view (e.g., pixel height of text) is outside of a threshold size window, a distance of the object from a viewpoint exceeds or is below a threshold distance, etc. as described with respect to FIG. 2A.

At block 408, the method 400 (based on the display attribute satisfying the criterion), modifies (e.g., enhances) the object or region in a second view of the XR environment as illustrated in FIGS. 2B-2E. In some implementations, modifying the object or region may include enlarging the object or region in the second view as described with respect to FIGS. 2B-2E. In some implementations, modifying the object or region may include modifying an illumination level associated with the object or region in the second view as described with respect to FIG. 2B. In some implementations, modifying the object or region may include segmenting the object or region out from the XR environment prior to performing the modifying. For example, an object 218 may be segmented out from an XR environment prior to modifying the object 218 as described with respect to FIG. 2A. In some implementations, modifying the object or region may include decreasing a size of the object or region, moving the object or region to another location within a user's field of view, etc.

In some implementations, modifying the object or region may include diminishing a view (e.g., mask out, make semi-transparent, blur out, etc.) of a background region surrounding the object or region as described with respect to FIGS. 2C-2E. In some implementations, modifying the object or region may include modifying a background region surrounding the object or region such that the background region is modified in a different manner (e.g., a different size, color, transparency level, etc.) than a modification for the object or region in the second view as described with respect to FIG. 2A-2E.

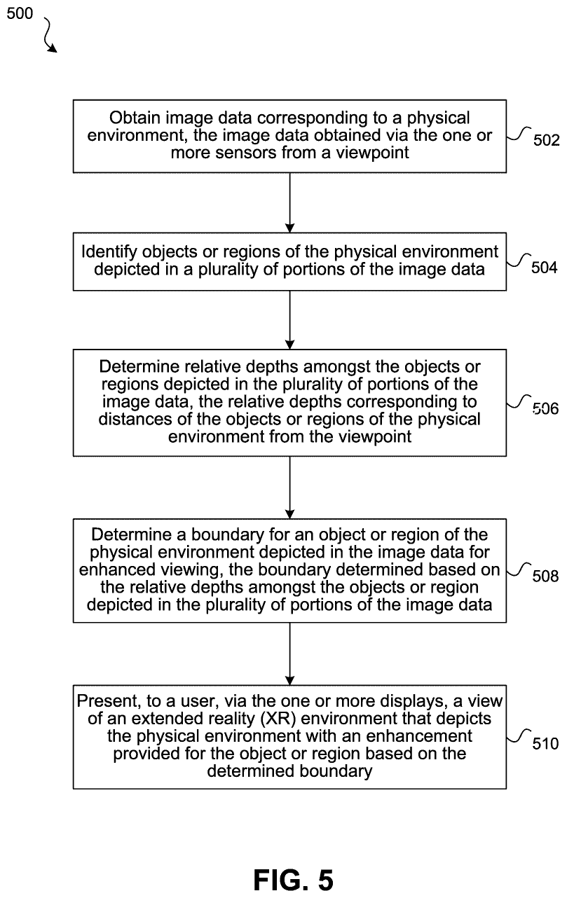

FIG. 5 is a flowchart representation of an exemplary method 500 that selects boundaries for an enhancement of a region within a view of an XR environment based on an understanding of the XR environment, in accordance with some implementations. In some implementations, the method 500 is performed by a device, such as a mobile device, desktop, laptop, HMD, or server device. In some implementations, the device has a screen for displaying images and/or a screen for viewing stereoscopic images such as a head-mounted display (HMD such as e.g., device 105 or 110 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

At block 502, the method 500 obtains image data (and/or depth data) corresponding to a physical environment. For example, image data and relative depths among objects as described with respect to FIG. 2. The image data may be obtained via one or more sensors with respect to a viewpoint.

At block 504, the method 500 identifies objects or regions of the physical environment depicted in a plurality of portions of the image data. For example, identifying objects or regions may include distinguishing different objects or regions from one another, determining object types or region types, performing semantic labeling or scene understanding, etc. as described with respect to FIG. 1.

At block 506, the method 500 determines relative depths amongst the objects or regions depicted in the plurality of portions of the image data. The relative depths may correspond to distances of the objects or regions of the physical environment from the viewpoint. For example, a relative depth may be associated with an object A located 5 feet away from a camera viewpoint and an object B adjacent to object A but located 10 feet away from the camera viewpoint as described with respect to FIG. 2A.

At block 508, the method 500 determines a boundary for an object or region of the physical environment depicted in the image data for enhanced viewing. The boundary may be determined based on the relative depths amongst the objects or regions (e.g., object 218 and additional objects or background region 216 as described with respect to FIG. 2A) depicted in the plurality of portions of the image data.

At block 510, the method 500 presents, to a user, via one or more displays, a view of an extended reality (XR) environment that depicts the physical environment with an enhancement (or modification) provided for the object or region based on the determined boundary. For example, a boundary for region 318 depicted in the image data may be determined for enhanced viewing as described with respect to FIG. 3A.

In some implementations, the enhancement includes enlarging the object or region. For example, a fully magnified view of object 218 (as described with respect to FIG. 2E), a magnified view of region 318 including a larger version of text 326 via intelligent zooming coupled with AI/ML image enhancement (as described with respect to FIG. 3B), etc.

In some implementations, the enhancement includes enhancing an illumination level associated with the object or region. For example, the object or region may be enhanced by using brighter and more illuminated colors as described with respect to FIG. 3B.

In some implementations, a view a background region surrounding the determined boundary may be diminished. For example, a background region 316 may be blurred out (e.g., made out of focus) as described with respect to FIG. 3D.

In some implementations, a background region surrounding the determined boundary may be enhanced in a different manner (e.g., a different size, color, transparency level, etc.) than the enhancement for the object or region. For example, a background region 316 may be presented as transparent as described with respect to FIG. 3E.

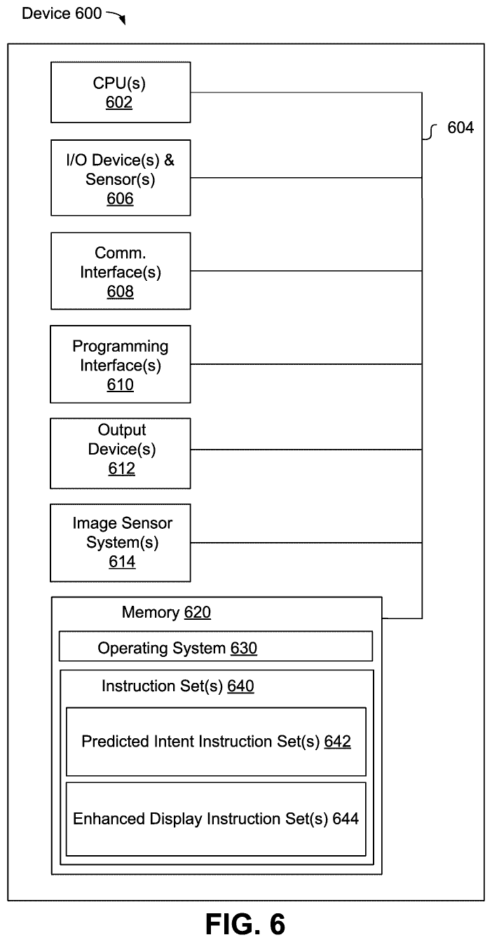

FIG. 6 is a block diagram of an example device 600. Device 600 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUS, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 612 are configured to present a view of a physical environment, a graphical environment, an extended reality environment, etc. to the user. In some implementations, the one or more displays 612 are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 612 correspond to diffractive, reflective, polarized, holographic, etc. waveguide displays. In one example, the device 600 includes a single display. In another example, the device 600 includes a display for each eye of the user.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a predicted intent instruction set 642 and an enhanced display instruction set 644. The instruction set(s) 640 may be embodied as a single software executable or multiple software executables.

The predicted intent instruction set 642 is configured with instructions executable by a processor to predict an intent to view at least a portion of an object or a region of an XR environment based on object or region identification and detected user activity.

The enhanced display instruction set 644 is configured with instructions executable by a processor to enhance an object or region displayed within a view of the XR environment.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor, one or more sensors and one or more displays:
presenting, to a user, via the one or more displays, a first view of an extended reality (XR) environment;
detecting an enhancement triggering condition associated with viewing at least a portion of an object or a region of the XR environment based on sensor data obtained via the one or more sensors, the enhancement triggering condition detected based on:
identifying a plurality of objects or regions of the XR environment;
determining that a display attribute associated with the object or region of the XR environment satisfies a criterion for enhanced display of the object or region; and
based on the display attribute satisfying the criterion, modifying the object or region in a second view of the XR environment.

2. The method of claim 1, wherein the display attribute comprises a size of the object or region.

3. The method of claim 2, wherein said determining that the display attribute satisfies the criterion comprises determining that the size of the object or region is outside a threshold size window.

4. The method of claim 1, wherein the display attributes comprise a distance between the object or region and a user viewpoint.

5. The method of claim 4, wherein said determining that the display attribute satisfies the criterion comprises determining that the distance between the object or region and the user viewpoint exceeds or is below a threshold distance value.

6. The method of claim 1, wherein said detecting the user activity comprises determining that a gaze of the user is directed at the object or region.

7. The method of claim 1, wherein said detecting the user activity comprises determining that the user initiates a specified gesture.

8. The method of claim 1, wherein said enhancing the object or region comprises enlarging the object or region in the second view.

9. The method of claim 1, wherein said enhancing the object or region comprises enhancing an illumination level associated with the object or region in the second view.

10. The method of claim 1, further comprising segmenting the object or region out from the XR environment prior to performing said enhancing.

11. The method of claim 1, further comprising diminishing a view a background region surrounding the object or region.

12. The method of claim 1, further comprising enhancing a background region surrounding the object or region, wherein said background region is enhanced in a different manner than an enhancement for the object or region in the second view.

13. The method of claim 1, wherein the region includes text.

14. The method of claim 1, wherein the enhancement triggering condition is further detected based on:
detecting a user activity indicative of the enhancement triggering condition.

15. A system comprising:
a processor;
a computer readable medium storing instructions that when executed by the processor cause the processor to perform operations comprising:
presenting, to a user, via one or more displays, a first view of an extended reality (XR) environment;
detecting an enhancement triggering condition associated with viewing at least a portion of an object or a region of the XR environment based on sensor data obtained via the one or more sensors, the enhancement triggering condition detected based on:
identifying a plurality of objects or regions of the XR environment;
determining that a display attribute associated with the object or region of the XR environment satisfies a criterion for enhanced display of the object or region; and
based on the display attribute satisfying the criterion, modifying the object or region in a second view of the XR environment.

16. The system of claim 15, wherein the display attribute comprises a size of the object or region.

17. The system of claim 16, wherein said determining that the display attribute satisfies the criterion comprises determining that the size of the object or region is outside a threshold size window.

18. The system of claim 15, wherein the display attributes comprise a distance between the object or region and a user viewpoint.

19. The system of claim 18, wherein said determining that the display attribute satisfies the criterion comprises determining that the distance between the object or region and the user viewpoint exceeds or is below a threshold distance value.

20. A non-transitory computer-readable medium comprising instructions that when executed by a processor cause the processor to perform operations comprising:
presenting, to a user, via one or more displays, a first view of an extended reality (XR) environment;
detecting an enhancement triggering condition associated with viewing at least a portion of an object or a region of the XR environment based on sensor data obtained via the one or more sensors, the enhancement triggering condition detected based on:
identifying a plurality of objects or regions of the XR environment;
determining that a display attribute associated with the object or region of the XR environment satisfies a criterion for enhanced display of the object or region; and
based on the display attribute satisfying the criterion, modifying the object or region in a second view of the XR environment.
